(19) United States
(12) Patent Application Publication
(10) Pub. No.: US 2024/0202825 A1
(43) Pub. Date: Jun. 20, 2024

(54) METHOD FOR OPTIMIZING POWER TRADING PROFIT OF A VIRTUAL POWER PLANT AND A SYSTEM THEREOF

(71) Applicant: HYUNDAI AUTOEVER CORP., Seoul (KR)

(72) Inventors: Dae Gun Ko, Seoul (KR); Claire Park, Seoul (KR); Kyung Hwan Park, Seoul (KR); Hae Lyong Choi, Seoul (KR)

(73) Assignee: HYUNDAI AUTOEVER CORP., Seoul (KR)

(21) Appl. No.: 18/541,451

(22) Filed: Dec. 15, 2023

(30) Foreign Application Priority Data
Dec. 19, 2022 (KR) 10-2022-0178186

(51) Int. Cl. G06Q 40/04

(52) U.S. Cl. CPC G06Q 40/04

(57) ABSTRACT

A method for optimizing power trading profits of a virtual power plant includes obtaining data on constraints of an optimal control model for optimizing power trading profits of the virtual power plant composed of renewable energy use devices including a first electric vehicle using a managed charging method (V1G), a second electric vehicle using a vehicle-to-grid charging method (V2G), an energy storage system (ESS), and a photovoltaic (PV); and inputting input data including a variable value to the optimal control model and outputting data on optimal power trading profits of the virtual power plant using an output value of the optimal control model. The variable value includes schedule data for each time zone of the first electric vehicle, schedule data for each time zone of the second electric vehicle, schedule data for each time zone of the ESS, and schedule data for each time zone of the PV.

### CROSS-REFERENCE TO RELATED APPLICATION

This application claims priority to and the benefit under 35 U.S.C. §119 of Korean Patent Application No. 10-2022-0178186 filed on Dec. 19, 2022 in the Korean Intellectual Property Office, the entire contents of which are incorporated herein by reference.

### TECHNICAL FIELD

The present disclosure relates to a method for optimizing power trading profits of a virtual power plant and a system to which the method is applied. More particularly, the present disclosure relates to a method for optimizing power trading profits by adjusting power trading costs and power trading profits of a virtual power plant using renewable energy, and a virtual power plant system to which the method is applied.

### BACKGROUND

The statements in this section merely provide background information related to the present disclosure and may not constitute prior art.

Recently, in Europe, about 50% of electricity consumption has been covered using renewable energy such as wind power and solar energy, and about 50% of a power generation amount using the renewable energy has been supplied to end consumers. In Germany, such power trading is possible through power brokerage operators. Therefore, as an interest in power brokerage business has recently increased, the importance of virtual power plant operators and virtual power plant operation technology has attracted attention.

A virtual power plant is a system that manages distributed power sources such as household photovoltaic power generation facilities as if the distributed power sources were a single power plant by integrating the distributed power sources with each other using cloud-based software. The virtual power plant operates various types of distributed power sources scattered within a power grid using information and communication technology and automatic control technology.

In order to implement RE100 through recently emerging environmental issues and carbon neutrality, technology for optimizing power trading profits of the virtual power plant by minimizing costs of power use in the virtual power plant and selling surplus power of the virtual power plant in a power trading market to generate power trading profits is desired.

### SUMMARY

Aspects of the present disclosure provide a method and a system for optimizing power trading profits of a virtual power plant.

Aspects of the present disclosure also provide a method and a system for minimizing power consumption costs and maximizing power trading profits in consideration of schedules of devices included in a virtual power plant and using renewable energy.

Aspects of the present disclosure also provide an optimal virtual power plant system for maximizing power trading profits by comparing power trading profits for each scenario of a virtual power plant through simulation each other.

However, aspects of the present disclosure are not restricted to those set forth herein. The above and other aspects of the present disclosure should become more apparent to one of ordinary skill in the art to which the present disclosure pertains by referencing the detailed description of the present disclosure given below.

According to an embodiment of the present disclosure, a method for optimizing power trading profits of a virtual power plant may be performed by a computing system and may comprise obtaining data on constraints of an optimal control model for optimizing power trading profits of the virtual power plant. The virtual power plant may comprise renewable energy use devices including a first electric vehicle using a managed charging method (V1G), a second electric vehicle using a vehicle-to-grid charging method (V2G), an energy storage system (ESS), and a photovoltaic (PV). The method may also comprise inputting input data including a variable value to the optimal control model and outputting data on optimal power trading profits of the virtual power plant using an output value of the optimal control model, under the constraints. The variable value includes schedule data for each time zone of the first electric vehicle, schedule data for each time zone of the second electric vehicle, schedule data for each time zone of the ESS, and schedule data for each time zone of the PV.

In another embodiment, the constraints may express that it is possible to participate in a power trading market for conducting power trading using the renewable energy use devices only for a pre-designated minimum trading time or more.

In another embodiment, the constraints may include a condition in which the first electric vehicle or the second electric vehicle participates in a power trading market only when it is connected to a pre-designated charging device to be in a standby state.

In another embodiment, the constraints may consider priorities given to each power trading market of a plurality of power trading markets.

In another embodiment, the input data may further include data on initial battery states of charge of the renewable energy use devices.

In another embodiment, the input data may further include data on a battery charging amount when the first electric vehicle departs according to a planned schedule of the first electric vehicle or data on a battery charging amount when the second electric vehicle departs according to a planned schedule of the second electric vehicle.

In another embodiment, the input data may further include a predicted solar energy power generation amount of the PV.

In another embodiment, the input data may further include predicted power demand for each building included in the virtual power plant.

In another embodiment, the method may further comprise calculating the predicted power demand for each building by inputting a power usage amount during a past pre-designated time, weather information, and date information to a power demand prediction model and using a result value extracted from the power demand prediction model.

In another embodiments, the method may further comprise finding, by the optimal control model, the variable value for deriving a minimum value of a difference between a charging cost value and a profit value during a schedule creation period. The charging cost may be a charging cost of the first electric vehicle, the second electric vehicle, and the ESS, and the profits may be profits of the first electric vehicle, the second electric vehicle, the ESS, and the PV.

In another embodiment, the constraints may include: a first condition in which it is possible to participate in a power trading market for conducting power trading using the renewable energy use devices every 4 hours, a second condition in which each of the renewable energy use devices creates only one schedule for each time zone, a third condition in which only a renewable energy use device that has obtained certification in advance among the renewable energy use devices participates in the power trading market, a fourth condition in which the first electric vehicle or the second electric vehicle participates in the power trading market only when it is on standby at an electric vehicle charger (EVC), a fifth condition in which hourly charging and discharging amounts of the renewable energy use devices follow established standards, and a sixth condition in which the renewable energy use devices most preferentially participate in a power trading market that has already successfully bid. The input data may include data on initial battery states of charge of the renewable energy use devices, data on a battery charging amount when the first electric vehicle or the second electric vehicle departs according to a planned schedule of the first electric vehicle or the second electric vehicle, a predicted solar energy power generation amount of the PV, and predicted power demand for each building included in the virtual power plant.

In another embodiment, the optimal control model may be a mixed integer linear programming (MILP) model. The method may further comprise calculating the predicted power demand for each building included in the virtual power plant and the predicted solar energy power generation amount of the PV by inputting a power usage amount during a past pre-designated time, weather information, and date information to a power demand prediction model and using a result value extracted from the power demand prediction model. The power demand prediction model may be a bidirectional long short-term memory (BLSTM) model.

According to another embodiment of the present disclosure, an operation server of a virtual power plant may comprise one or more processors, a memory configured to store one or more instructions, and a communication interface. The one or more processors may, by executing the stored one or more instructions, perform an operation of obtaining data on constraints of an optimal control model for optimizing power trading profits of the virtual power plant. The virtual power plant may comprise renewable energy use devices including a first electric vehicle using a managed charging method (V1G), a second electric vehicle using a vehicle-to-grid charging method (V2G), an ESS, and a PV. The one or more processors may also perform an operation of inputting input data including a variable value to the optimal control model and outputting data on optimal power trading profits of the virtual power plant using an output value of the optimal control model, under the constraints. The variable value may include schedule data for each time zone of the first electric vehicle, schedule data for each time zone of the second electric vehicle, schedule data for each time zone of the ESS, and schedule data for each time zone of the PV.

In another embodiment, the constraints may include: i) a condition in which it is possible to participate in a power trading market for conducting power trading using the renewable energy use devices every 4 hours, ii) a condition in which each of the renewable energy use devices creates only one schedule for each time zone, iii) a condition in which only a renewable energy use device that has obtained certification in advance among the renewable energy use devices participates in the power trading market, iv) a condition in which the first electric vehicle or the second electric vehicle participates in the power trading market only when it is on standby at an EVC, v) a condition in which hourly charging and discharging amounts of the renewable energy use devices follow established standards, and vi) a condition in which the renewable energy use devices most preferentially participate in a power trading market that has already successfully bid.

In another embodiment, the input data may include data on initial battery states of charge of the renewable energy use devices, data on a battery charging amount when the first electric vehicle or the second electric vehicle departs according to a planned schedule of the first electric vehicle or the second electric vehicle, a predicted solar energy power generation amount of the PV, and predicted power demand for each building included in the virtual power plant.

In another embodiment, the optimal control model may be a MILP model, the predicted power demand for each building included in the virtual power plant. The predicted solar energy power generation amount of the PV may be values calculated by inputting a power usage amount during a past pre-designated time, weather information, and date information to a power demand prediction model and using a result value extracted from the power demand prediction model. The power demand prediction model may be a BLSTM model.

In another embodiment, the optimal control model may be a model configured to find the variable value for deriving a minimum value of a difference between a charging cost value and a profit value during a schedule creation period. The charging cost may be a charging cost of the first electric vehicle, the second electric vehicle, and the ESS. The profits may be profits of the first electric vehicle, the second electric vehicle, the ESS, and the PV.

### BRIEF DESCRIPTION OF THE DRAWINGS

The above and other aspects and features of the present disclosure should become more apparent by describing in detail embodiments thereof with reference to the attached drawings, in which:

FIG. 1 is a configuration diagram of a virtual power plant system according to an embodiment of the present disclosure;

FIG. 2 is a diagram for describing devices constituting a virtual power plant system according to another embodiment of the present disclosure;

FIG. 3 is a flowchart for describing a method for optimizing power trading profits of a virtual power plant according to still another embodiment of the present disclosure;

FIGS. 4A, 4B, and 4C are detailed flowcharts for describing, in more detail, a method for extracting a predicted variable value described with reference to FIG. 3;

FIG. 5 is a power rate unit price graph for each time zone and a power rate unit price table for each time zone; and

FIG. 6 is a hardware configuration diagram of a computing system according to some embodiments of the present disclosure.

### DETAILED DESCRIPTION

Hereinafter, embodiments of the present disclosure are described with reference to the drawings. Advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments are provided so that the present disclosure is thorough and complete and fully conveys the concept of the disclosure to those having ordinary skill in the art. The scope of the present disclosure is defined by the appended claims and their equivalents.

In describing the present disclosure, when it is determined that the detailed description of the related well-known configuration or function may obscure the gist of the present disclosure, the detailed description thereof has been omitted.

When a component, device, element, or the like of the present disclosure is described as having a purpose or performing an operation, function, or the like, the component, device, or element should be considered herein as being “configured to” meet that purpose or to perform that operation or function.

The term “unit” or “module” used in the present disclosure signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

Before describing some embodiments, the meanings of some terms mentioned in the present disclosure are described. V0G, V1G, and V2G to be described below may be types of methods for charging electric vehicles.

Unmanaged charging (V0G) may refer to a simple charging method. For example, V0G is a method in which an internal battery of an electric vehicle may be charged at a constant speed up to a chargeable maximum capacity when a charger is connected to the electric vehicle. Accordingly, an electric vehicle using the V0G charging method (V0G electric vehicle) may be an electric vehicle charged by the simple charging method.

Managed charging (V1G) may be a smart charging method improved compared to the simple charging method. V1G is a method capable of changing the time or speed required for an electric vehicle to be charged in order to provide a service to a grid. Here, the grid may refer to a network connected in order to supply electricity. In addition, here, V1G may be one-way V2G. Accordingly, an electric vehicle using the V1G charging method (V1G electric vehicle) may be an electric vehicle charged by a one-way smart charging method.

Vehicle-to-grid (V2G) is a two-way system and may be a charging method in which energy may be transferred from a charging station to a vehicle and energy may be transferred from a vehicle to a charging station. In other words, V2G may refer to a charging method in which energy exchange is possible between the vehicle and the grid. Trading of electricity may be conducted by transmitting the electricity to a power brokerage operator using a V2G charging method. Accordingly, an electric vehicle using the V2G charging method (V2G electric vehicle) may be an electric vehicle that may be charged or discharged by a two-way smart charging method.

Hereinafter, some embodiments of the present disclosure are described with reference to the drawings.

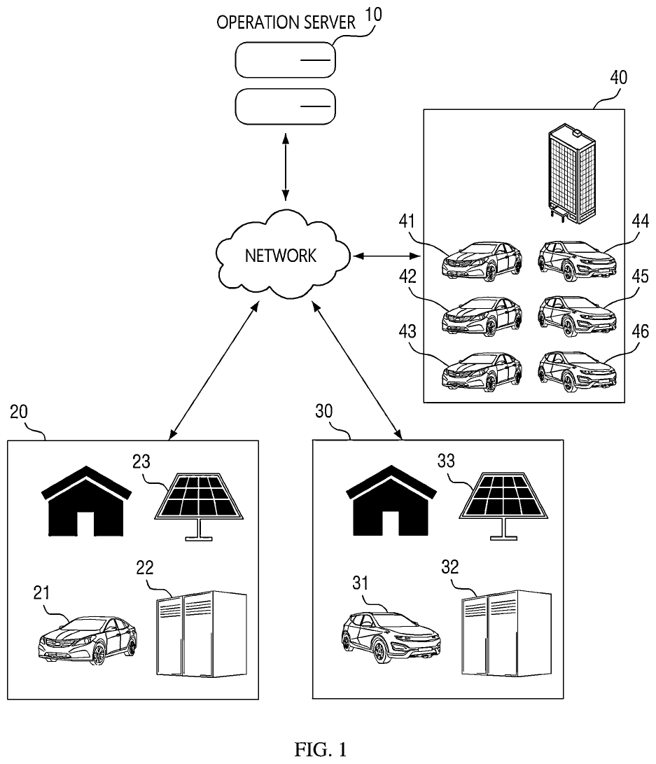

FIG. 1 is a configuration diagram of a virtual power plant system according to an embodiment of the present disclosure.

As illustrated in FIG. 1, the virtual power plant system may include an operation server 10, a first home energy management system (HEMS) 20, a second home energy management system 30, and a building energy management system (BEMS) 40. Here, the number of home energy management systems and the number of building energy management systems are not limited thereto, and the virtual power plant system may include a plurality of home energy management systems and building energy management systems. Furthermore, the virtual power plant system may include a factory energy management system (FEMS).

The first home energy management system 20 may include a V1G electric vehicle 21, a first energy storage system (ESS) 22, and a first photovoltaics (PV) 23. Here, the numbers of V1G electric vehicles, ESSs, and PVs included in the first home energy management system 20 are not limited thereto, and the first home energy management system 20 may include a plurality of V1G electric vehicles, ESSs, or PVs. In an embodiment, some devices may be excluded.

The second home energy management system 30 may include a V2G electric vehicle 31, a second ESS 32, and a second PV 33. Here, the numbers of V2G electric vehicles, ESSs, and PVs included in the second home energy management system 30 are not limited thereto, and the second home energy management system 30 may include a plurality of V2G electric vehicles, ESSs, or PVs. In an embodiment, some devices may be excluded.

According to an embodiment, the first home energy management system 20 may include a V2G electric vehicle, and the second home energy management system 30 may include a V1G electric vehicle.

The building energy management system 40 may include V1G electric vehicles 41, 42, and 43 and V2G electric vehicles 44, 45, and 46. Here, the numbers of V1G electric vehicles and V2G electric vehicles are not limited thereto. For example, the building energy management system 40 may include only V2G electric vehicles.

According to some embodiments, the PV may serve to convert solar energy into electric energy and store the electric energy. The ESS may serve to utilize pre-stored power when a power consumption price is high. The V2G electric vehicle may play the role of charging or discharging by any V2G electric vehicle user when the demand and supply of power are unstable. The V1G electric vehicles may contribute to stabilization of the supply and demand of power through charging when the supply of the power is greater than the demand of the power.

According to an embodiment, the home energy management system 20 or 30 or the building energy management system 40 may include various known renewable energy use devices as well as the V1G electric vehicle, the V2G electric vehicle, the ESS, and the PV.

The operation server 10 may operate a virtual power plant so as to derive optimal power trading profits of the virtual power plant using an optimal control model for optimizing power trading profits based on input data such as an operation plan of devices included in the home energy management systems 20 and 30 and the building energy management system 40.

According to an embodiment, the operation server 10 may receive schedule data for each time zone of the ESS, the electric vehicle, and the PV included in each system from the first home energy management system 20, the second home energy management system 30, and the building energy management system 40 through a network.

Here, a schedule for each time zone may be any one of charging, discharging, standby, participation in a discharging market for power trading, participation in a frequency stabilization market, and an error schedule for each time zone.

According to an embodiment, the operation server 10 may optimize power trading profits by inputting the schedule data for each time zone of the devices including the V1G electric vehicle, the V2G electric vehicle, the ESS, and the PV, and the like, received from each of the systems 20, 30, and 40, weather information, date information, and other input data to an optimal control model. The operation server 10 may optimize the power trading profits also by maximizing power trading profits and minimizing power consumption costs using result values extracted from the optimal control model. Here, the power trading profits may include market participation profits obtained by participating in a power trading market and arbitrage trading profits through the power trading market or the like. Hereinafter, a method for optimizing power trading profits is described in detail below.

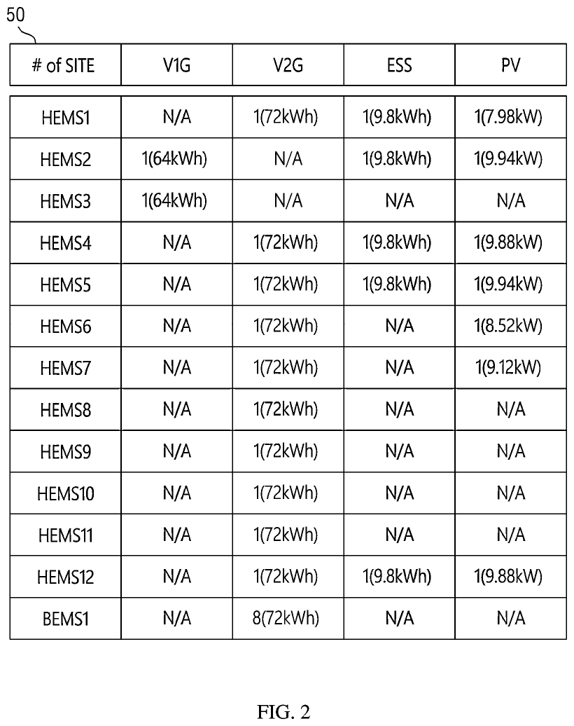

FIG. 2 is a diagram for describing devices constituting a virtual power plant system according to another embodiment of the present disclosure.

Referring to FIG. 2, a table 50 illustrating a configuration of a first virtual power plant system utilized in some embodiments of the present disclosure is presented. The first virtual power plant system may include an operation server, like the virtual power plant system in FIG. 1.

According to an embodiment, the first virtual power plant system may include home energy management systems HEMS1 to HEMS12 and a building energy management system BEMS1.

Each energy management system may include a V1G electric vehicle, a V2G electric vehicle, an ESS, and/or a PV, and a detailed configuration of each energy management system is presented in a configuration table 50 of the first virtual power plant system.

The contents described in FIG. 1 may be equally applied to functions of the respective home energy management systems, the building energy management system, and the operation server, a network, and the like, of the first virtual power plant system.

It should be noted that the respective components of the virtual power plant system illustrated in FIGS. 1 and 2 represent functional elements that are functionally divided. However, a plurality of components may be implemented in a form in which the plurality of components are integrated with each other in an actual physical environment. For example, at least some of the first home energy management system 20 and the second home energy management system 30 may be implemented in the form of different logics within one physical computing device.

In addition, the respective components may be implemented in a form in which they are separated into a plurality of detailed functional elements in an actual physical environment. For example, a first function of the operation server 10 may be implemented in a first computing device and a second function of the operation server 10 may be implemented in a second computing device.

So far, the virtual power plant system and a network environment according to some embodiments of the present disclosure have been described with reference to FIGS. 1 and 2. Hereinafter, a method for optimizing power trading profits of a virtual power plant according to various embodiments of the present disclosure is described in detail. In order to provide convenience of understanding, a description of the method is provided on the assumption that an environment is an environment illustrated in FIG. 1 or FIG. 2, but it should be easily understood by one of ordinary skill in the art that an environment in which a differential update is provided may be variously modified.

Each step of methods to be described below may be performed by a computing device. In other words, each step of the methods may be implemented as one or more instructions executed by a processor of the computing device. All steps included in the methods may be performed by a single physical computing device or first steps of the methods may be performed by a first computing device and second steps of the methods may be performed by a second computing device. In other words, each step of the method may be performed by a computing system. Hereinafter, unless otherwise specified, a description is provided on the assumption that each step of the method is performed by the operation server 10. However, for convenience of explanation, a description of an operation subject of each step included in the method may be omitted. In addition, in methods to be described below, an execution order of respective operations may be changed within the range in which the execution order may be logically changed, if necessary.

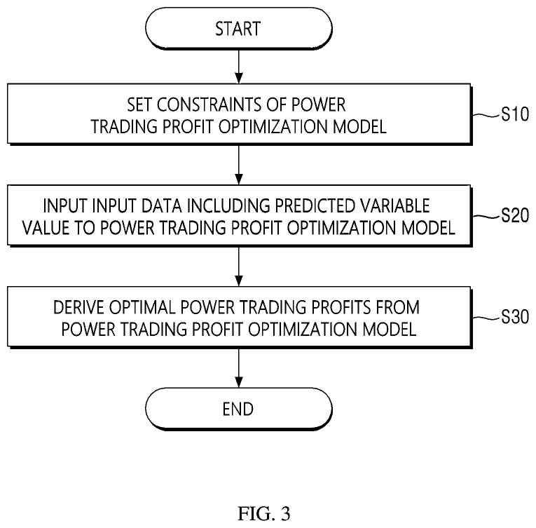

FIG. 3 is a flowchart for describing a method for optimizing power trading profits of a virtual power plant according to still another embodiment of the present disclosure.

Hereinafter, an optimal control model that generates an optimal control schedule may be utilized in order to optimize power trading profits. Here, for example, mixed integer linear programming (MILP) may be utilized as the optimal control model. Here, the mixed integer linear programming is a method for deriving a solution to a model in which some of variables used in a simulation model are integers, and the mixed integer linear programming may be described as a technique for solving a problem of determining variables causing a linear function to have a minimum or a maximum while satisfying constraints.

According to an embodiment, the optimal control model may be a model that extracts an objective function value using Equation 1.

$$Objective Function = arg min ( {J}_{s . c} - {J}_{profit} ) \qquad [ Equation 1 ]$$

Referring to Equation 1, J_{s.c} may be a charging cost value of the electric vehicle and the ESS, and J_{profit} may be a profit value of the electric vehicle, the ESS, and the PV.

Specifically, J_{s.c} may be calculated using Equation 2.

$${J}_{s c} = {\sum }_{t} {\sum }_{E V , E S S} ( ( {EV}_{capa} + E S {S}_{c a p a} ) \times {TOU}_{t} ) \qquad [ Equation 2 ]$$

Referring to Equation 2, EV_{capa} may be a charging amount (KW) of the electric vehicle (EV) at a corresponding time, ESS_{capa} may be a charging amount (kW) of the ESS at the corresponding time, and TOUₜ may be a charging power unit price (kW/Eurocent) at the corresponding time. In other words, J_{s.c} may refer to a cost required for charging the electric vehicle and the ESS during a schedule creation period. Here, the schedule creation period may be 2 days.

In addition, specifically, J_{profit} may be calculated using Equation 3.

$${J}_{profit} = {\sum }_{t} ( {PV}_{profit} + {Market}_{profit} + {Arbitrage}_{profit} ) \qquad [ Equation 3 ]$$

Referring to Equation 3, PV_{profit} may be (charging amount of PV at corresponding time−power usage amount of building)×TOUₜ. Here, the building may be, for example, a building of an energy management system including the corresponding PV. Market_{profit} may be FCR_{profit}+FR_{profit}.

Here, FCR_{profit} may be calculated using Equation 4.

$$F C {R}_{profit} : {\sum }_{t} ( {FCR}_{capa} \times Capacity {Cost}_{FCR} ) \qquad [ Equation 4 ]$$

Referring to Equation 4, FCR_{capa} may be an FCR participation capacity for each time, and CapacityCost_{FRC} may be a cost of profits obtained per 1MW at a corresponding time.

In addition, here, FR_{profit} may be calculated using Equation 5.

$${FR}_{profit} : {\sum }_{t} ( {aFRR ( - )}_{profit} + {aFRR ( + )}_{profit} + {mFRR ( - )}_{profit} + {mFRR ( + )}_{profit} ) \qquad [ Equation 5 ]$$

Here, aFRR(−)profit may be calculated using Equation 6.

$${aFRR ( - )}_{profit} : ( Capacity {Cost}_{aFRR ( - )} - {Signal}_{aFRR ( - )} \times {TOU}_{t} - Energy {Cost}_{aFrr ( - )} ) \times {aFRR ( - )}_{capa} \qquad [ Equation 6 ]$$

aFFR(+)_{profit}, mFFR(−)_{profit}, and mFFR(+)profit of Equation 5 may also be calculated in the same manner as Equation 6.

In the case of an FCR market, which is a clear market, only a capacity cost may be guaranteed. In the case of an FR market, which is a bid market, when power is put on standby at a corresponding time, profits corresponding to a capacity cost may be generated, and when a response request is actually generated from a power transmission operator and a power response is actually performed, additional profits corresponding to an energy cost may be generated. The energy cost may become a profit value per MW when a response actually occurs, and a signal value may be an occurrence probability value of the response. In other words, for example, as a response probability in the FR market, aFRR may be considered as 2% and mFRR may be considered as 0%, and corresponding constant values may be used.

An objective function calculated using Equations 1 to 6, i.e., a mixed integer linear programming model, may be applied in a specific method for optimizing power trading profits of a virtual power plant to be described below.

Referring to FIG. 3, first, in S10, constraints of a power trading profit optimization model in a virtual power plant system may be set.

Hereinafter, the constraints of the power trading profit optimization model in the virtual power plant system according to an embodiment of the present disclosure may be conditions presented in Table 1.

TABLE 1

| No. | Constraint Content |
|---|---|
| 1 | It is possible to participate in a power trading market every 4 |
| | hours. |
| 2 | Each equipment (a V2G electric vehicle, a V1G electric vehicle, |
| | an ESS, a PV, etc.) included in a virtual power plant may create |
| | only one schedule. |
| 3 | Each equipment included in the virtual power plant may participate |
| | only in a power trading market for which it has obtained |
| | certification in advance. |
| 4 | An electric vehicle may participate in the power trading market |
| | only in a state in which it is on standby at an electric vehicle |
| | charger (EVC). |
| 5 | Hourly charging and discharging amounts of each equipment |
| | included in the virtual power plant follow established standards. |
| 6 | Each equipment included in the virtual power plant may create a |
| | schedule only within a battery allowable range. |
| 7 | It is assumed that a target battery amount is charged according to a |
| | user departure time schedule of the electric vehicle. |
| 8 | Each equipment included in the virtual power plant most |
| | preferentially participates in a power trading market that has |
| | already successfully bid. |

According to an embodiment, referring to Table 1, in Constraint 1, it may be possible to participate in a power trading market for conducting power trading using renewable energy use devices only for a pre-designated minimum trading time or more.

For example, the power trading market in Constraint 1 may be a German power trading market, and it is possible to participate in FCR, aFRR(−), aFRR(+), mFRR(−), and mFRR, which are five trading markets in the German power trading market, every 4 hours.

For example, a time unit in which it is possible to participate in the German power trading market may be divided into a total of 6 timeslots, which may be 0:00 to 4:00 (Timeslot 1), 4:00 to 8:00 (Timeslot 2), and 8:00 to 12:00 (Timeslot 3), 12:00 to 16:00 (Timeslot 4), 16:00 to 20:00 (Timeslot 5), or 20:00 to 24:00 (Timeslot 6).

According to an embodiment, a schedule of each of the devices in Table 1 may be any one of charging, discharging, standby, participation in a discharging market for power trading, participation in a frequency stabilization market, and an error schedule for each time zone, as described above.

According to an embodiment, in Constraint 4, the V1G electric vehicle or the V2G electric vehicle may participate in the power trading market only when it is connected to a pre-designated charging device to be in a standby state.

According to an embodiment, in Constraint 3, priorities given to each power trading market of a plurality of power trading markets may be considered. For example, each equipment included in the virtual power plant may only participate in a power trading market for which it has obtained certification in advance.

In S20, input data including a predicted variable value may be input to the power trading profit optimization model.

According to an embodiment, the input data may include data presented in Table 2.

TABLE 2

| No. | Input Data |
|---|---|
| 1 | Operation schedules of renewable energy use devices |
| 2 | Initial battery state of charge of each equipment included in |
| | virtual power plant |
| 3 | Target battery charging amount when electric vehicle included in |
| | virtual power plant departs according to planned schedule of |
| | electric vehicle |
| 4 | Predicted value of solar energy power generation amount |
| 5 | Predicted value of power demand for each building included in |
| | virtual power plant |
| 6 | Time of used price (TOUP) |
| 7 | Predicted value of hourly power trading price |

According to an embodiment, referring to Table 2, the operation schedules of the renewable energy use devices of Input Data 1 may include an operation schedule of an electric vehicle, and the operation schedule of the electric vehicle may be operation schedules of the electric vehicle of the day and tomorrow. Here, the electric vehicle may be the V1G and V2G electric vehicles included in each energy management system of the virtual power plant.

In addition, the operation schedules of the renewable energy use devices of Input Data 1 may include a variable value, and the variable value may include schedule data for each time zone of the V1G electric vehicle, schedule data for each time zone of the V2G electric vehicle, schedule data for each time zone of the ESS, and schedule data for each time zone of the PV.

According to an embodiment, referring to Table 2, the planned schedule of the electric vehicle of Input Data 3 may be the operation schedule of the electric vehicle of the renewable energy use devices of Input Data 1.

According to an embodiment, referring to Table 2, the solar energy power generation amount of Input Data 4 may be a solar energy power generation amount of the PV included in the virtual power plant.

According to an embodiment, referring to Table 2, the hourly power trading price of Input Data 7 may be a power trading price traded in the German power trading market, and may be a power trading price traded in FCR, aFRR(−), aFRR(+), mFRR(−), or mFRR(+).

According to the above-described embodiments, it is possible to maximize profits according to power trading of the virtual power plant by minimizing power consumption costs of the virtual power plant and maximizing power trading profits of the virtual power plant in consideration of all of the schedules, various constraints, and the like, of the devices using renewable energy included in the virtual power plant.

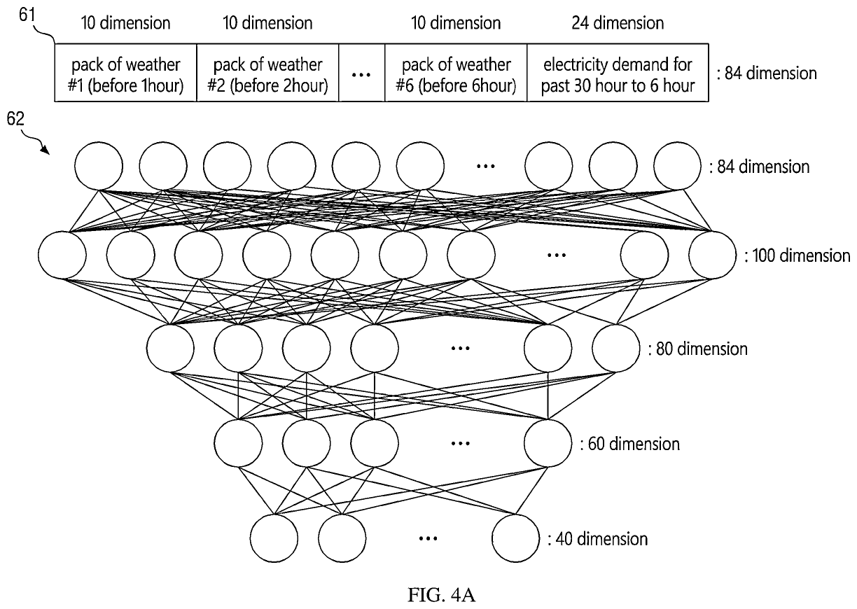

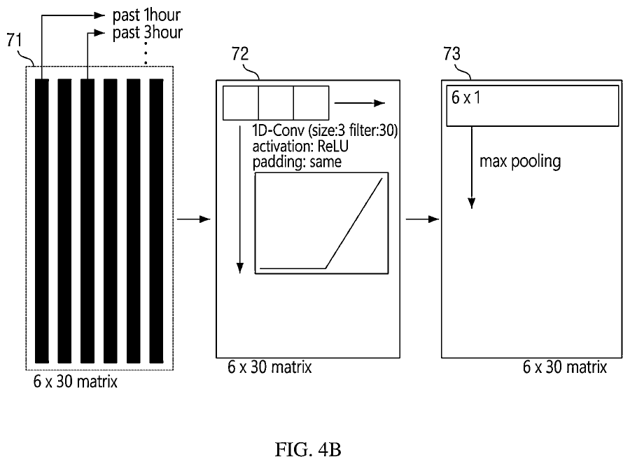

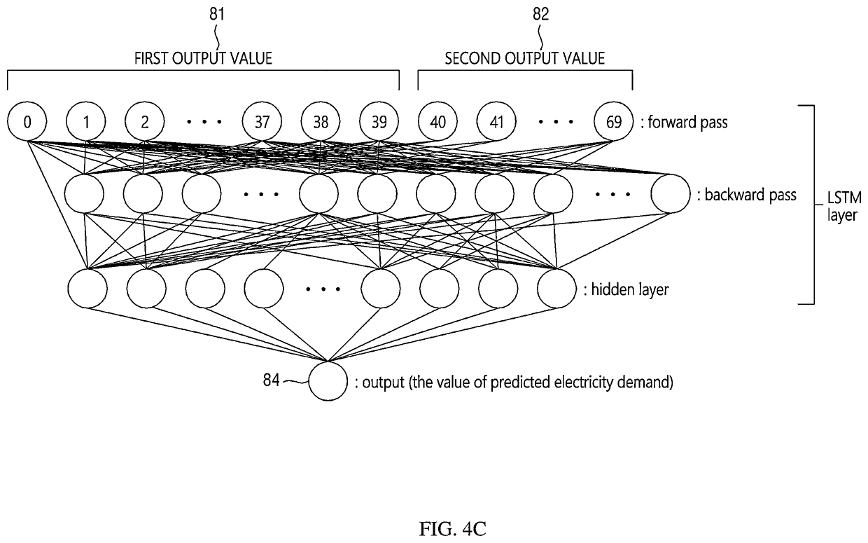

According to an embodiment, referring to Table 2, the predicted value of Input Data 5 may be extracted using power demand prediction modeling. Hereinafter, a power demand prediction model according to the present disclosure is described with reference to FIGS. 4A to 4C.

FIGS. 4A, 4B, and 4C are detailed flowcharts for describing, in more detail, a method for extracting a predicted variable value described with reference to FIG. 3.

According to an embodiment, in order to predict power demand, weather information and date information may be input to a multi-layer perceptron (MLP), first output values may be extracted from the MLP, power usage amount data may be input to a convolutional neural network (CNN), second output values may be extracted from the CNN, second input values obtained by concatenating the first output values and the second output values to each others may be input to a bidirectional long short-term memory (BLSTM), and a predicted value of power demand for a total of 48 hours, i.c., power demand for 2 days, in one hour units may be finally derived using result values extracted from the BLSTM.

Referring to FIG. 4A, 84-dimensional input data 61 and an MLP model 62 are presented. First, the 84-dimensional input data 61 may include weather information before 1 hour to weather information before 6 hours, each weather information may be composed of 10-dimensional packs, and each pack may include a total of 10 types of data such as humidity, temperature, the highest temperature, the lowest temperature, other weather information, year, month, day, day of the week information, and the presence or absence of a holiday. Here, five types of data such as the humidity, the temperature, the highest temperature, the lowest temperature, and other weather information include information related to weather, and five types of data such as the year, the month, the day, the day of the week information, and the presence or absence of the holiday include information related to a date.

Accordingly, the weather information before 1 hour to the weather information before 6 hours may include a total of 60-dimensional data.

In addition, actual power demand data for 24 hours may be added as input data input to the MLP.

Accordingly, a total of 84-dimensional data including information related to weather before 1 hour to before 6 hours, date information, actual power demand data for 24 hours, and the like, may be input as input data input to the MLP.

The input data may be input to the MLP and pass through respective layers of 100 dimensions, 80 dimensions, and 60 dimensions to extract first output values including 40-dimensional vectors.

Referring to FIG. 4B, a power usage amount before past 1 hour, a power usage amount before past 2 hours, a power usage amount before past 3 hours, a power usage amount before past 4 hours, a power usage amount before past 5 hours, and a power usage amount before past 6 hours may be input to the CNN to extract second output values of 30 vectors.

Referring to FIG. 4C, concatenated input data (70-dimensional vectors) obtained by concatenating the extracted first output values (40-dimensional vectors) and the extracted second output values (30-dimensional vectors) to each other may be input to the BLSTM, and a predicted value of power demand for a total of 48 hours in one hour units may be derived from result values.

According to an embodiment, the number of hidden layers of the BLSTM may be one, and the hidden layer may be composed of 100 sizes or 200 sizes. As a structure of the BLSTM, various known modeling structures extracting a predicted value may be utilized.

According to an embodiment, a predicted value extraction model for generating an optimal control schedule, including MLP, CNN, and BLSTM models may be applied to prediction of the power demand but may also be utilized to predict a PV power generation amount and predict a power price.

Hereinafter, with respect to a configuration of the table 50 illustrating the configuration of the virtual power plant system presented in FIG. 2 according to an embodiment of the present disclosure, profit results according to optimization of power trading profits of the virtual power plant according to three scenarios using MILP optimal control modeling according to the present disclosure are described based on the constraints in Table 1 and the input data in Table 2.

Here, profits according to arbitrage trading are power trading profits of a first virtual power plant through power trading in the German power trading market.

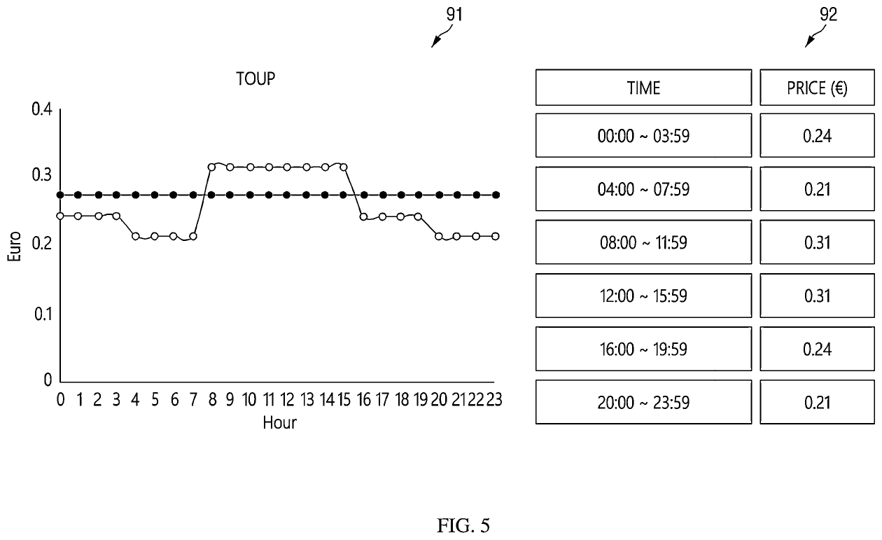

Here, it is assumed that unit prices presented in a power rate unit price graph 91 for each time zone and a power rate unit price table 92 for each time zone illustrated in FIG. 5 are applied as the TOUP of the German power trading market.

According to an embodiment, conditions of each of Scenarios 1 to 3 are as presented in Table 3.

TABLE 3

| Scenario No. | #1 | #2 | #3 |
|---|---|---|---|
| Battery of electric | 5%~95% | | |
| vehicle | | | |
| Battery of ESS | 0%~100% | | |
| Number of PVs | 7 (7.98 kW~9.88 kW) | | |
| Number of ESSs | 5 (9.8 kWh) | | |
| ESS charging | Grid/PV | PV | Grid/PV |
| method | (PCS + Inverter) | (PCS) | (PCS + Inverter) |
| Number of V1G | 20 (64 kWh) | 2 (64 kWh) | |
| electric vehicles | | | |
| Number of V2G | 0 | 18 (72 kWh) | |
| electric vehicles | | | |
| Whether or not | N/A | Not allowed | Allowed |
| V2B/H is allowed | | | |
| Expected SoC at the | 20% | | |
| time of entrance of | | | |
| vehicle | | | |
| Total number of | 11 houses and 1 building | | |
| households | | | |

Referring to Table 3, in Scenarios 1 to 3, in common, a usage range of the battery of the electric vehicle is 5% to 95%, and a usage range of the battery of the ESS is 0% to 100%. In addition, it is assumed that the number of PVs is 7 in common and power generation amounts of the PVs are 7.98 kW to 9.88 KW, it is assumed that the number of ESSs is 5 in common and the ESSs have a capacity of 9.8 kWh, and it is assumed that a state of charge at the time of entrance of the electric vehicle is 20%. It is assumed that the total number of households is 11 houses and 1 building in common, which is based on the configuration table 50 of the virtual power plant system presented in FIG. 2.

Here, Scenario 1 is composed only of V1G electric vehicles that may only be charged, and in Scenario 1, charging of the ESS from the grid is possible because an inverter that may convert alternating current (AC) electricity into direct current (DC) electricity is installed in the ESS. In addition, Scenario 2 is composed of 18 V2G electric vehicles that may be charged and discharged, and in Scenario 2, it is assumed that that discharging to the building (V2B/H) is not possible in consideration of battery efficiency and it is assumed that charging of the ESS from the grid is not possible and only charging of the ESS from the PV is possible because an inverter is not installed in the ESS. In Scenario 3, discharging of the V2G electric vehicle to the building is possible, such that it is possible to derive profits through power arbitrage trading unlike Scenarios 1 and 2.

Profit results for Scenario 1 to Scenario 3 are as presented in Table 4.

TABLE 4

| Unit (Euro) | | | #1 | #2 | #3 |
|---|---|---|---|---|---|
| HEMS | EV | Market | 230 | 596 | 717 |
| | | participation | | | |
| | | profits | | | |
| | | PV | 2,909 | 3,034 | 2,988 |
| | | Arbitrage trading | 0 | 0 | 1,221 |
| | | profits | | | |
| | | Sum | 3,139 | 3,630 | 4,926 |
| | ESS | Market | 534 | 334 | 381 |
| | | participation | | | |
| | | profits | | | |
| | | PV | 97 | 62 | 43 |
| | | Arbitrage trading | 403 | 715 | 601 |
| | | profits | | | |
| | | Sum | 1,034 | 1,111 | 1,025 |

| BEMS | Market | 87 | 890 | 275 |
|---|---|---|---|---|
| | participation | | | |
| | profits | | | |
| | Arbitrage trading | 0 | 0 | 13,534 |
| | profits | | | |
| | Sum | 87 | 890 | 13,809 |

| | | | |
|---|---|---|---|
| Sum of profits | 4,261 | 5,632 | 19,761 |

Referring to Table 4, profits corresponding to market participation presented in Table 4 are profits obtained by participating in FCR, aFRR(−), aFRR(+), mFRR(−), and mFRR(+) of the German power trading market, PV profits are profits generated from solar charging, and PV profits in each of the EV and the ESS are illustrated. The arbitrage trading profits are arbitrage trading profit calculated by applying a power trading unit price determined for each time zone in FIG. 5 and using a calculation method of (discharging time/electric charge—charging time/electric charge).

Referring to Table 4, a scenario that generates the most profits from the first virtual power plant is Scenario 3, and it may be confirmed that the most profits are generated from a vehicle to building (V2B) portion of the electric vehicle that generates profits by performing charging when a power rate is low and performing discharging to the building when a power rate is high.

Referring to Table 4, it may be confirmed that the most profits were generated from arbitrage trading in the BEMS, that is, the V2B portion, the second most profits were generated from solar energy charging by the PV, and the least profits were generated from market participation.

According to the above-described embodiments, it is possible to discover an optimal configuration of the virtual power plant system that maximizes power trading profits by comparing power trading profits for each scenario of the virtual power plant through simulation each other.

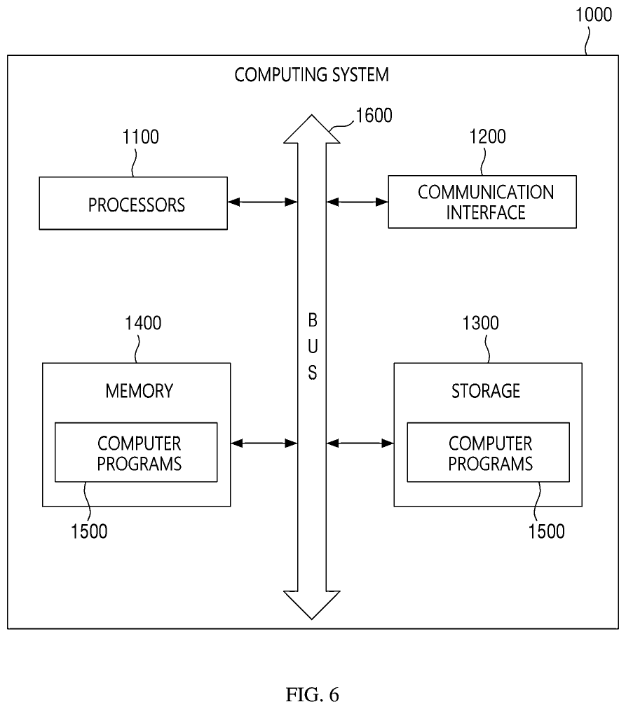

FIG. 6 is a hardware configuration diagram of a computing system according to some embodiments of the present disclosure. The computing system 1000 illustrated in FIG. 6 may refer to, for example, a computing system including the operation server 10 described with reference to FIG. 1 and may refer to a computing system including the first home energy management system 20. The computing system 1000 may include one or more processors 1100, a system bus 1600, a communication interface 1200, a memory 1400 loading a computer program 1500 executed by the processor 1100, and a storage 1300 storing the computer program 1500.

The processor 1100 controls overall operations of respective components of the computing system 1000. The processor 1100 may perform an arithmetic operation on at least one application or program for executing methods/operations according to various embodiments of the present disclosure. Here, the processor 1100 may be, for example, a microprocessor.

The memory 1400 stores various data, commands, and/or information. The memory 1400 may load one or more computer programs 1500 from the storage 1300 in order to execute the methods/operations according to various embodiments of the present disclosure. The bus 1600 provides a communication function between the components of computing device 1000. The communication interface 1200 supports Internet communication of the computing system 1000. The storage 1300 may non-temporarily store one or more computer programs 1500. The computer program 1500 may include one or more instructions in which the methods/operations according to various embodiments of the present disclosure are implemented. When the computer program 1500 is loaded into the memory 1400, the processor 1100 may perform the methods/operations according to various embodiments of the present disclosure by executing the one or more instructions.

In some embodiments, the computer program 1500 may include instructions for performing an operation of selecting constraints of an optimal control model for optimizing power trading profits of a virtual power plant composed of renewable energy use devices including a V1G electric vehicle, a V2G electric vehicle, an energy storage system (ESS), and a photovoltaic (PV) and an operation of inputting input data including a variable value to the optimal control model and deriving optimal power trading profits of the virtual power plant using an output value of the optimal control model, under the selected constraints, for example, in a method performed by a computing system. The variable value includes schedule data for each time zone of the V1G electric vehicle, the V2G electric vehicle, the ESS, and the PV.

So far, various embodiments of the present disclosure and effects according to these embodiments have been mentioned with reference to FIGS. 1-6. The effects according to the technical spirit of the present disclosure are not limited to the aforementioned effects, and various other effects may be obviously understood by one of ordinary skill in the art to which the present disclosure pertains by referencing the detailed description of the present disclosure given below.

The technical spirit of the present disclosure described so far may be implemented as computer-readable codes on a computer-readable medium. The computer program recorded on the computer-readable recording medium may be transmitted to another computing device through a network such as the Internet, installed on another computing device, and thus used on another computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. In concluding the detailed description, those having ordinary skill in the art should appreciate that many variations and modifications can be made to the embodiments without substantially departing from the principles of the present disclosure. Therefore, the disclosed embodiments of the present disclosure are used in a generic and descriptive sense only and not for purposes of limitation.

The protection scope of the present disclosure should be interpreted by the following claims, and all technical ideas within the equivalent range should be interpreted as being included in the scope of the present disclosure.

What is claimed is:

1. A method for optimizing power trading profits of a virtual power plant, the method being performed by a computing system, the method comprising:
obtaining data on constraints of an optimal control model for optimizing power trading profits of the virtual power plant, wherein the virtual power plant comprises renewable energy use devices including a first electric vehicle using a managed charging method (V1G), a second electric vehicle using a vehicle-to-grid charging method (V2G), an energy storage system (ESS), and a photovoltaic (PV); and
inputting input data, including a variable value, to the optimal control model and outputting data on optimal power trading profits of the virtual power plant using an output value of the optimal control model, under the constraints,
wherein the variable value includes schedule data for each time zone of the first electric vehicle, schedule data for each time zone of the second electric vehicle, schedule data for each time zone of the ESS, and schedule data for each time zone of the PV.

2. The method of claim 1, wherein the constraints express that it is possible to participate in a power trading market for conducting power trading using the renewable energy use devices only for a pre-designated minimum trading time or more.

3. The method of claim 1, wherein the constraints include a condition in which the first electric vehicle or the second electric vehicle participates in a power trading market only when it is connected to a pre-designated charging device to be in a standby state.

4. The method of claim 1, wherein the constraints consider priorities given to each power trading market of a plurality of power trading markets.

5. The method of claim 1, wherein the input data further includes data on initial battery states of charge of the renewable energy use devices.

6. The method of claim 1, wherein the input data further includes data on a battery charging amount when the first electric vehicle departs according to a planned schedule of the first electric vehicle or data on a battery charging amount when the second electric vehicle departs according to a planned schedule of the second electric vehicle.

7. The method of claim 1, wherein the input data further includes a predicted solar energy power generation amount of the PV.

8. The method of claim 1, wherein the input data further includes predicted power demand for each building included in the virtual power plant.

9. The method of claim 8, further comprising: calculating the predicted power demand for each building by inputting a power usage amount during a past pre-designated time, weather information, and date information to a power demand prediction model and using a result value extracted from the power demand prediction model.

10. The method of claim 1, further comprising: finding, by the optimal control model, the variable value for deriving a minimum value of a difference between a charging cost value and a profit value during a schedule creation period,
wherein the charging cost is a charging cost of the first electric vehicle, the second electric vehicle, and the ESS, and
wherein the profits are profits of the first electric vehicle, the second electric vehicle, the ESS, and the PV.

11. The method of claim 1, wherein the constraints include a condition in which it is possible to participate in a power trading market for conducting power trading using the renewable energy use devices every 4 hours, a condition in which each of the renewable energy use devices creates only one schedule for each time zone, a condition in which only a renewable energy use device that has obtained certification in advance among the renewable energy use devices participates in the power trading market, a condition in which the first electric vehicle or the second electric vehicle participates in the power trading market only when it is on standby at an electric vehicle charger (EVC), a condition in which hourly charging and discharging amounts of the renewable energy use devices follow established standards, and a condition in which the renewable energy use devices most preferentially participate in a power trading market that has already successfully bid, and
wherein the input data includes data on initial battery states of charge of the renewable energy use devices, data on a battery charging amount when the first electric vehicle or the second electric vehicle departs according to a planned schedule of the first electric vehicle or the second electric vehicle, a predicted solar energy power generation amount of the PV, and predicted power demand for each building included in the virtual power plant.

12. The method of claim 11, wherein the optimal control model is a mixed integer linear programming (MILP) model,
wherein the method further comprises calculating the predicted power demand for each building included in the virtual power plant and the predicted solar energy power generation amount of the PV by inputting a power usage amount during a past pre-designated time, weather information, and date information to a power demand prediction model and using a result value extracted from the power demand prediction model, and
wherein the power demand prediction model is a bidirectional long short-term memory (BLSTM) model.

13. An operation server of a virtual power plant, comprising:
one or more processors;
a memory configured to store one or more instructions; and
a communication interface,
wherein the one or more processors are configured, by executing the stored one or more instructions, to:
perform an operation of obtaining data on constraints of an optimal control model for optimizing power trading profits of the virtual power plant, wherein the virtual power plant comprises renewable energy use devices including a first electric vehicle using a managed charging method (V1G), a second electric vehicle using a vehicle-to-grid charging method (V2G), an energy storage system (ESS), and a photovoltaic (PV); and
perform an operation of inputting input data including a variable value to the optimal control model and outputting data on optimal power trading profits of the virtual power plant using an output value of the optimal control model, under the constraints,
wherein the variable value includes schedule data for each time zone of the first electric vehicle, schedule data for each time zone of the second electric vehicle, schedule data for each time zone of the ESS, and schedule data for each time zone of the PV.

14. The operation server of claim 13, wherein the constraints include a condition in which it is possible to participate in a power trading market for conducting power trading using the renewable energy use devices every 4 hours, a condition in which each of the renewable energy use devices creates only one schedule for each time zone, a condition in which only a renewable energy use device that has obtained certification in advance among the renewable energy use devices participates in the power trading market, a condition in which the first electric vehicle or the second electric vehicle participates in the power trading market only when it is on standby at an electric vehicle charger (EVC), a condition in which hourly charging and discharging amounts of the renewable energy use devices follow established standards, and a condition in which the renewable energy use devices most preferentially participate in a power trading market that has already successfully bid.

15. The operation server of claim 13, wherein the input data includes data on initial battery states of charge of the renewable energy use devices, data on a battery charging amount when the first electric vehicle or the second electric vehicle departs according to a planned schedule of the first electric vehicle or the second electric vehicle, a predicted solar energy power generation amount of the PV, and predicted power demand for each building included in the virtual power plant.

16. The operation server of claim 15, wherein the optimal control model is a mixed integer linear programming (MILP) model,
wherein the predicted power demand for each building included in the virtual power plant and the predicted solar energy power generation amount of the PV are values calculated by inputting a power usage amount during a past pre-designated time, weather information, and date information to a power demand prediction model and using a result value extracted from the power demand prediction model, and
wherein the power demand prediction model is a bidirectional long short-term memory (BLSTM) model.

17. The operation server of claim 13, wherein the optimal control model is a model configured to find the variable value for deriving a minimum value of a difference between a charging cost value and a profit value during a schedule creation period,
wherein the charging cost is a charging cost of the first electric vehicle, the second electric vehicle, and the ESS, and
wherein the profits are profits of the first electric vehicle, the second electric vehicle, the ESS, and the PV.
